(19) United States
(12) Patent Application Publication
(10) Pub. No.: US 2026/0366693 A1
(43) Pub. Date: Nov. 19, 2026

(54) FLEXIBLE SURFACE LIGHT GUIDE FOR A VEHICLE

(71) Applicant: VALEO VISION, Bobigny (FR)

(72) Inventors: Rabih TALEB, Bobigny (FR); Hafid EL-IDRISSI, Bobigny (FR)

(73) Assignee: VALEO VISION, Bobigny (FR)

(21) Appl. No.: 19/133,823

(22) PCT Filed: Dec. 1, 2023
(86) PCT No.: PCT/EP2023/084021

§ 371 Date: May 29, 2025

(30) Foreign Application Priority Data
Dec. 2, 2022 (FR) FR2212684

(51) Int. Cl. F21S 43/235; F21S 43/249

(52) U.S. Cl. CPC F21S 43/252; F21S 43/249

(57) ABSTRACT

The invention relates to a flexible surface light guide for a vehicle. The light guide includes a plurality of groups of light-injecting elements and a light guide sheet, each group being coupled to at least one light source. The light guide sheet includes a plurality of regions, at least one light-emitting zone being incorporated into at least one region. The light guide sheet being adjacent to the light-injecting elements, each group being configured to illuminate a region in the light guide sheet. Furthermore, the light-injecting elements of a group illuminating a region have a length which is different from that of the light-injecting elements of the other groups illuminating another region.

### TECHNICAL FIELD

The present invention relates to a light guide for a vehicle. It is applicable in particular, but not limited, to automotive vehicles.

### BACKGROUND OF THE INVENTION

An example of a light guide known to the person skilled in the art is shown in FIG. 1 and carries reference sign 5. This light guide 5 is used for example in decorative objects in order to illuminate them, and comprises:
a plurality of groups 50 of light-injecting elements 500, each group 50 being coupled to at least one light source 60,
a light guide sheet 51 comprising a plurality of regions 510 and a light-emitting zone 511 incorporated into a region 510, said light guide sheet 51 being adjacent to said light-injecting elements 500, each group 50 being configured to illuminate the region 510 in said light guide sheet 51.

Each group 50 is designed in the same way: the light-injecting elements 500 of a group 50 are adjacent to one another, and have different lengths which increase with the distance from the light sources 60. Also, each light-injecting element 500 of a group 50 has the same length as another light-injecting element 500 of another group 50. The light-injecting elements 500 of a group 50 are folded and superposed so as to form a stack with an extremity. Each light-injecting element 500 therefore comprises a fold. Said at least one light source 60 coupled to said group 50 is configured to emit light rays, which enter via the extremity of the stack and can thus be propagated in said light-injecting elements 500 as far as the light guide sheet 51. As illustrated in FIG. 1, said at least one light source 60 coupled to each group 500 is arranged on an electronic support 61. Thus there are as many electronic supports 61 as there are groups 50 of light-injecting elements 500. As illustrated in FIG. 1, there are three groups 50 of light-injecting elements 500 and hence three electronic supports 61. Two electronic supports 61 are situated between two groups 50. Each light source 60 has a luminous power of around 80 lumens.

A drawback of this prior art is that the light sources 60 used are too low-powered for an automotive vehicle application, and there is no space between the groups 50 of light-injecting elements 500 to arrange light sources with higher power-which are consequently larger-with suitable electronic supports and suitable heat sinks (also larger) for dissipating the heat produced by these higher-powered light sources.

### SUMMARY OF THE INVENTION

In this context, the present invention aims to propose a light guide that makes it possible to overcome the aforementioned drawback.

To this end, the invention proposes a flexible surface light guide for a vehicle, the light guide comprising:
a plurality of groups of light-injecting elements and a light guide sheet, each group being coupled to at least one light source, characterized in that:
the light guide sheet comprises a plurality of regions, at least one light-emitting zone being incorporated into at least one region, said light guide sheet being adjacent to said light-injecting elements, each group being configured to illuminate a region in said light guide sheet,
and in that the light-injecting elements of a group illuminating a region have a length which is different from that of the light-injecting elements of the other groups illuminating another region.

Thus, as will be seen in detail below, thanks to the fact that the length of each light-injecting element is different from one group to another, at least one of the light sources coupled to the light-injecting elements may be located away from the light guide sheet, such that the light sources are placed in a less confined space and hence overcome the limitations of location. It is thus possible to have an electronic support which is sufficiently large to receive all the light sources, and a heat sink of size suitable for cooling the remote light source or the set of light sources.

According to non-limiting embodiments, said light guide may also have one or more of the following additional features, taken alone or in any technically possible combinations.

According to a non-limiting embodiment, in each group of light-injecting elements, said light-injecting elements are folded so as to form a stack with a thickness adapted to an emission surface of a light source, the stack having an inlet surface configured to receive the light emitted by the light source.

According to a non-limiting embodiment, the light-injecting elements are dimensioned in such a way that the inlet surfaces of the groups of light-injecting elements are at the same level when the light-injecting elements of each of these groups are folded.

In this way, the light sources arranged facing these inlet surfaces may be positioned approximately at the same level, which means that the installation of the complete system can be simplified. In particular, when the plurality of groups of light-injecting elements is arranged on the same side of the guide sheet, the light sources—since they are at the same level—can be mounted on a same printed circuit board for reasons of simplicity. Also, because all the light sources are on a same support, a support surface can be provided which is larger than the individual support of each of the light sources when the latter are at different levels. The large support surface allows the association of a heat sink with a high heat dissipation capacity, which avoids the overheating of the light sources and allows these sources to be used for the long term.

For example, the guide sheet extends in a first direction and in a second direction, said directions forming an extent plane of the guide sheet. With respect to the light-injecting elements, in an unfolded state, they extend mainly in the first direction. To achieve a folded state, the light-injecting elements are folded in the second direction and in a same way. The length of the light-injecting elements, measured in the first direction, is dimensioned such that in the folded state, the inlet surfaces of the groups of light-injecting elements are at the same level, i.e. at the same position on the axis of the second direction. Moreover, the inlet surfaces are positioned at different places on the axis of the first direction.

According to a non-limiting embodiment, the light guide may be mounted on a front face of the vehicle, in a mounting position in which the extent plane of the guide sheet is perpendicular to the longitudinal axis of the vehicle. In this way, the entire surface of the guide sheet in the extent plane can be seen from the outside of the vehicle. The guide sheet has a plurality of regions, each incorporating a light-emitting zone. These regions are arranged offset in the second direction, and the number of regions corresponds to the number of groups of injecting elements.

According to a non-limiting embodiment, said light guide is transparent.

According to a non-limiting embodiment, said at least one light-emitting zone forms at least one pattern.

According to a non-limiting embodiment, said plurality of groups of light-injecting elements is arranged on a same side of said light guide sheet and thus forms a first set of light-injecting elements.

According to a non-limiting embodiment, the plurality of groups of light-injecting elements is arranged on a first side of said light guide sheet and thus forms a first set of light-injecting elements, wherein the light guide comprises a second set identical to the first set, said second set being arranged on a second side of said light guide sheet opposite the first side, so as to be symmetrical to the first set relative to said light guide sheet.

According to a non-limiting embodiment, said light sources are coupled to at least one light collimator. This allows a reduction in light losses from the light sources and hence improves the efficiency of the light propagation.

According to a non-limiting embodiment, a set of light sources coupled to a group is supplied by a different current from the other sets of light sources coupled to other groups. This allows the creation of animations.

In a non-limiting embodiment, the light sources are semiconductor light sources.

According to a non-limiting embodiment, said light sources are activatable independently of one another. This allows the creation of animations.

Also, a luminous device for a vehicle is proposed, characterized in that it comprises at least one light guide according to any of the preceding features, a plurality of light sources and at least one heat sink.

According to non-limiting embodiments, said luminous device may further comprise one or more of the following additional features, implemented alone or in any technically possible combination.

According to a non-limiting embodiment, the light sources are arranged on a same electronic support.

According to a non-limiting embodiment, the light sources are arranged on a same plane of said same electronic support.

According to a non-limiting embodiment, each light source is arranged on a different plane of said same electronic support from the other light sources.

According to a non-limiting embodiment, said luminous device comprises at least two superposed light guides which are oriented opposite to one another.

According to a non-limiting embodiment of the luminous device,
in each group of light-injecting elements, the light-injecting elements are folded so as to form a stack with a thickness adapted to an emission surface of a light source, the stack having an inlet surface receiving the light emitted by the corresponding light source,
the light-injecting elements are dimensioned in such a way that the inlet surfaces are at the same level when the light-injecting elements of each of the groups are folded.

### BRIEF DESCRIPTION OF DRAWINGS

The invention and the various applications thereof will be understood more clearly from reading the following description and studying the accompanying figures:

FIG. 1 is a schematic illustration of a light guide according to the prior art, said light guide comprising groups of light-injecting elements coupled to light sources, and a light guide sheet,

FIG. 2 is a schematic illustration of a light guide of a vehicle, said light guide comprising three groups of light-injecting elements coupled to light sources, and a light guide sheet comprising regions and at least one light-emitting zone, the three groups of injecting elements being arranged on a same side of the light guide sheet according to a first embodiment variant of a non-limiting embodiment of the invention,

FIG. 3 is a schematic illustration of a light guide of the vehicle, said light guide comprising six groups of light-injecting elements coupled to light sources, and a light guide sheet comprising regions and at least one light-emitting zone, the six groups of injecting elements being arranged on a same side of the light guide sheet according to a first embodiment variant of a non-limiting embodiment of the invention,

FIG. 4 is a schematic illustration of a light guide of a vehicle, said light guide comprising six groups of light-injecting elements coupled to light sources, and a light guide sheet comprising regions and at least one light-emitting zone, the six groups of injecting elements being arranged on both sides of the light guide sheet according to a second embodiment variant of a non-limiting embodiment of the invention,

FIG. 5 is an enlarged view of a part of the light-injecting elements of a light guide according to FIG. 2, 3, 4 or 5,

FIG. 6 is a front view of a stack of light-injecting elements within a same group of light-injecting elements of a light guide according to FIG. 2, 3, 4 or 5,

FIG. 7 illustrates said light guide from FIG. 2 with said light-injecting elements, which are unfolded, according to a non-limiting embodiment,

FIG. 8 is an enlarged, perspective view of some light-injecting elements of a group of a light guide according to FIG. 2, 3, 4 or 5, in a non-limiting embodiment,

FIG. 9 is a schematic illustration of the light guide from FIG. 2, said light guide sheet comprising three regions with three light-emitting zones forming a pattern, according to a first non-limiting embodiment of the pattern,

FIG. 10 is a schematic illustration of the light guide from FIG. 2, said light guide sheet comprising three regions with three light-emitting zones forming three patterns, according to a second non-limiting embodiment of the pattern,

FIG. 11 is a schematic illustration of a luminous device of a vehicle, said luminous device comprising said light guide from FIG. 2, light sources, an electronic support, and a heat sink, the light sources being arranged on said electronic support according to a first embodiment variant of a first non-limiting embodiment of the luminous device,

FIG. 12 is a schematic representation of the luminous device from FIG. 11, said luminous device further comprising a light collimator, according to a non-limiting embodiment,

FIG. 13 is a schematic illustration of a luminous device of a vehicle, said luminous device comprising said light guide from FIG. 2, light sources, an electronic support, and a heat sink, the light sources being arranged on said electronic support according to a second embodiment variant of a first non-limiting embodiment of the luminous device,

FIG. 14 is a schematic illustration of a luminous device of a vehicle, said luminous device comprising said light guide from FIG. 2 comprising two sets of groups of light-injecting elements arranged on either side of said light guide sheet, light sources, two electronic supports, and two heat sinks, according to a second non-limiting embodiment of the luminous device, and

FIG. 15 is a schematic illustration of a luminous device of a vehicle, said luminous device comprising two superposed light guides from FIG. 14, light sources, four electronic supports, and four heat sinks, according to a third non-limiting embodiment of the luminous device.

### DETAILED DESCRIPTION OF THE INVENTION

Elements that are identical in terms of structure or function, and which appear in different figures, are denoted by the same reference signs unless specified otherwise.

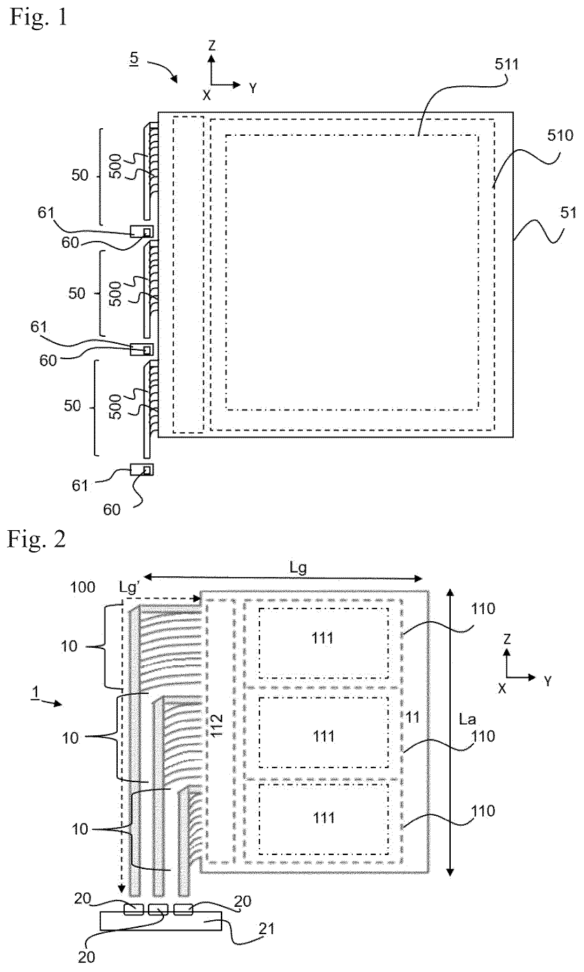

The light guide 1 according to the invention is described with reference to FIGS. 2 to 15. The light guide 1 is a light guide for a vehicle 3. In a non-limiting embodiment, the vehicle 3 is an automotive vehicle. “Automotive vehicle” means any type of motorized vehicle. This embodiment is given as a non-limiting example in the remainder of the description. In the remainder of the description, the vehicle 3 is thus also called an automotive vehicle 3. In a non-limiting embodiment variant, the vehicle 3 is a combustion-engined vehicle or an electric vehicle.

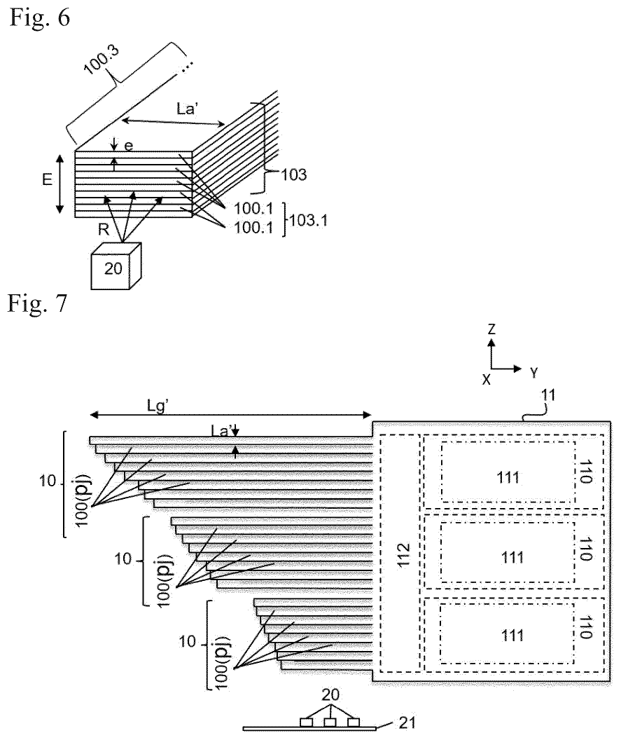

The light guide 1 is sheet-like and flexible. It can therefore be adapted to any type of flat or curved surface. A light guide sheet is understood to mean an optical guide element, one of the dimensions of which is spatially much smaller than the other two dimensions, for example smaller by one or more orders of magnitude. Here, the thickness e of the light guide 1 is much smaller than its length Lg and its width La. In a non-limiting embodiment, the light guide 1 has a thickness e (shown in FIG. 6) of between 10 and 1000 microns. In a non-limiting embodiment variant, the thickness e is between 50 and 1000 microns. In a non-limiting example, the thickness e is 50 microns. The light guide 1 is thus very thin.

In a non-limiting embodiment, the light guide 1 is transparent. The light guide 1 is thus also called a transparent film 1. Because it is transparent, light can pass through it. Because the light guide 1 is transparent, a pattern (called a manufacturer's pattern) can be seen through said light guide 1, said pattern being incorporated into the front face or headlight or rear light of the motor vehicle 3 (if provided in the latter), when the light guide 1 is not lit, namely when it is not emitting light. This also allows the color of the body of the motor vehicle 3 to be retained when the light guide 1 is not lit. At night, in order to illuminate the manufacturer's pattern, the light guide 1 comprises a pattern 111 (described below) which may be identical to the manufacturer's pattern and which thus allows illumination of the manufacturer's pattern.

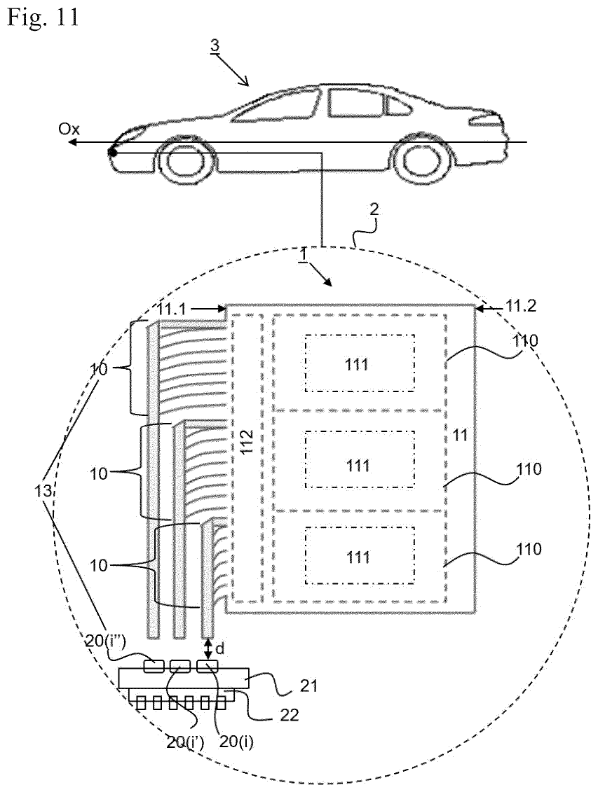

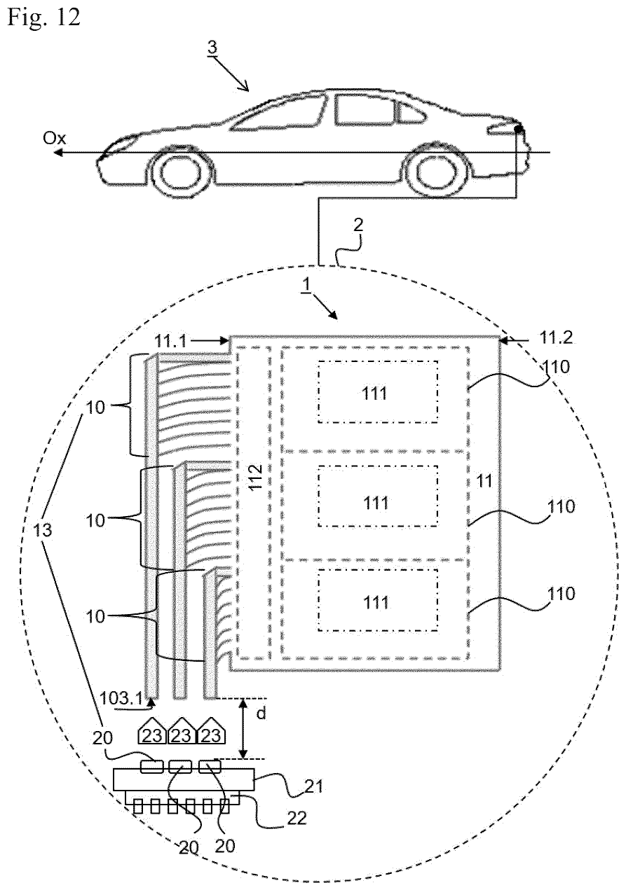

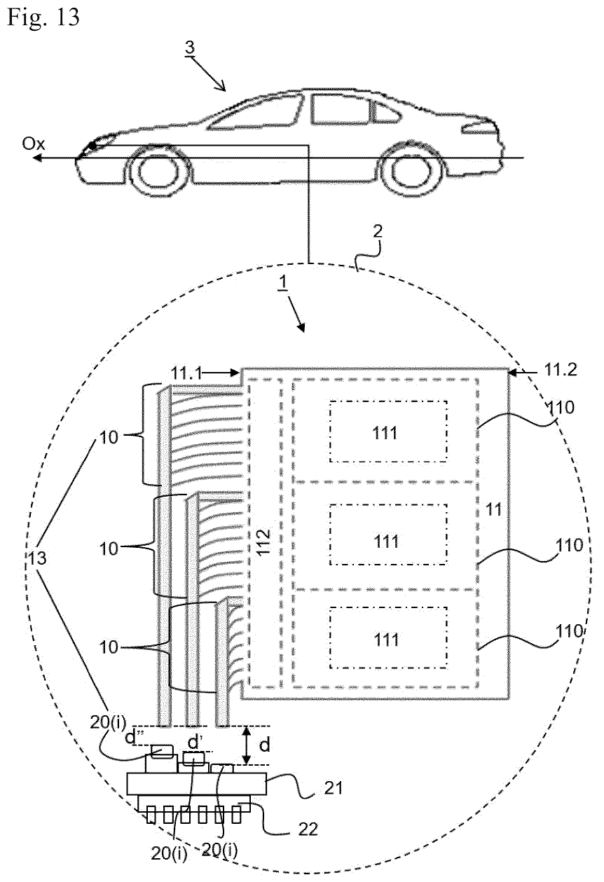

Because it is sheet-like, flexible and transparent, the light guide 1 is configured to be placed on the front face of the automotive vehicle 3 (as shown in FIG. 11) or also on a headlight (as shown in FIG. 13) or a rear light of the automotive vehicle 3 (as shown in FIG. 12). In a first non-limiting embodiment, the light guide 1 is bonded. In a first non-limiting embodiment variant, the surface (such as an outer lens of the front face, of the headlight, of the rear light) on which the light guide 1 is placed comprises an adhesive surface for bonding the light guide 1. In a second non-limiting embodiment variant, it is the rear face of the light guide 1 which comprises an adhesive surface and which is bonded behind a decorative piece. In a third non-limiting embodiment variant, both faces of the light guide 1 are adhesive. In a second non-limiting embodiment, the light guide 1 is not bonded but held between the outer lens and the decorative piece.

In a non-limiting embodiment, the light guide 1 is made of polycarbonate (PC), polymethyl methacrylate (PMMA), thermoplastic polyurethane (TPU), or polyethylene terephthalate (PET). Such materials allow a transparent and flexible light guide 1 to be produced.

As illustrated in FIGS. 2, 3 and 4, in a non-limiting embodiment, the light guide 1 extends in its width La along an axis z and in its length Lg along an axis y, which are substantially perpendicular to the axis x. It is noted that the width La and the length Lg may be equal.

As illustrated in FIGS. 2, 3 and 4, the light guide 1 comprises:
a plurality of groups 10 of light-injecting elements 100, and
a light guide sheet 11 comprising a plurality of regions 110.

The light guide sheet 11 extends in a first direction y and in a second direction z. In the unfolded state, the light-injecting elements 100 extend mainly in the first direction y, in a non-limiting embodiment. The dimension measured in this first direction y is thus considered as the length Lg′ of the light-injecting element 100 as illustrated in FIG. 7.

It is noted that, during the production process of the light guide 1, the light-injecting elements 100 and the light guide sheet 11 are made from a large sheet which will be trimmed at one extremity in order to separate the different light-injecting elements 100 along the axis y illustrated in FIG. 7, and thus form the different light-injecting elements 100 and the light guide sheet 11. Thus the light-injecting elements 100 remain attached to the light guide sheet 11 at one of their extremities 100.1.

The large sheet from which the light guide sheet 11 and the light-injecting elements 100 are formed comprises a flexible film and envelope layers arranged on either side of the flexible film. A layer of glue or adhesive is positioned between the flexible film and the envelope layers. The layer of glue or adhesive has a refractive index different from that of the flexible film, so as to cause propagation of the light rays in the flexible film by total internal reflection; hence the use of the name “light guide” to designate the assembly of the guide sheet and the light-injecting elements.

The groups 10 and the light-injecting elements 100 are described below.

In a non-limiting embodiment, the number of groups 10 is between two and twenty.

It is noted that, in the examples illustrated in FIGS. 7 to 13 and 15, only eight light-injecting elements 100 per group 10 have been shown, in comparison with FIGS. 2, 4 and 14 which show ten.

Each group 10 is configured to illuminate a region 110 (described below) in the light guide sheet 11.

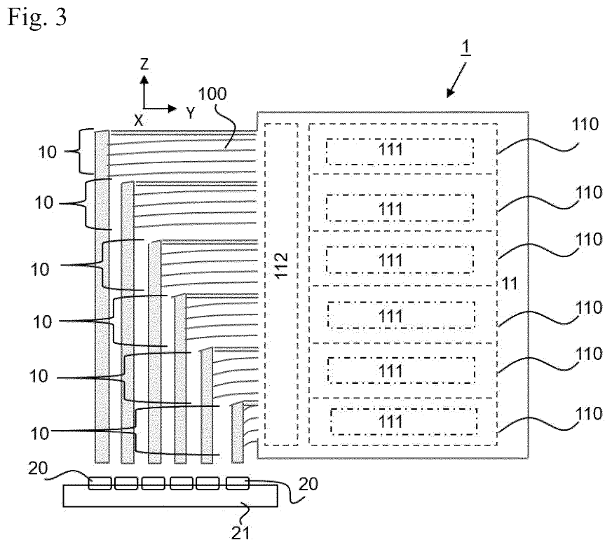

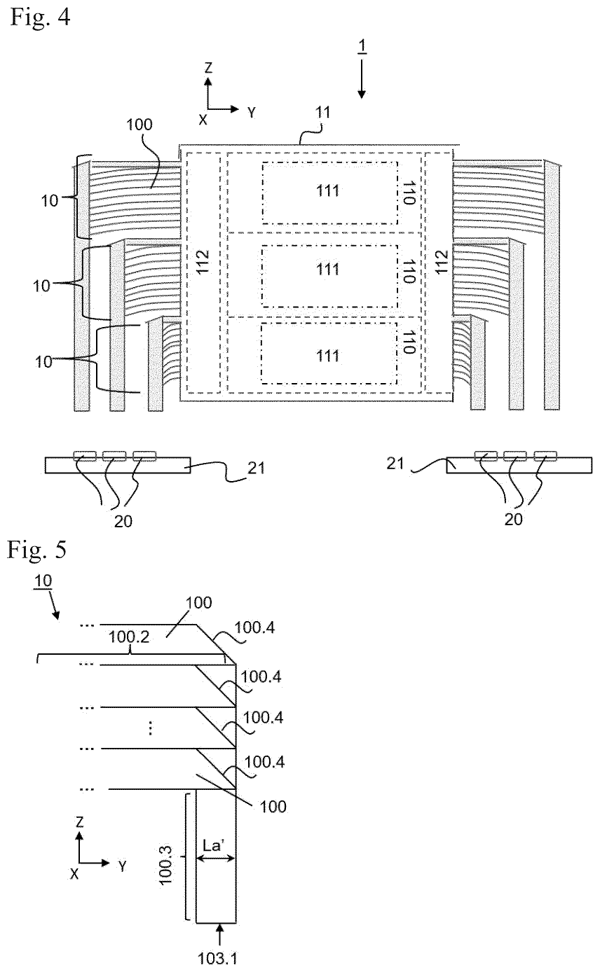

A group 10 may comprise one or more light-injecting elements 100. In a non-limiting embodiment, the group comprises between three and ten light-injecting elements 100. In a non-limiting variant embodiment, it comprises ten light-injecting elements 100. In the non-limiting example of FIGS. 2 and 4, the light guide 1 comprises three groups 10, and each group comprises ten light-injecting elements 100. In the non-limiting example of FIG. 3, the light guide comprises six groups 10, and each group comprises five light-injecting elements 100. In comparison with the example of FIGS. 2 and 4, the number of groups 10 has been doubled, and consequently the number of light-injecting elements 100 per group 10 has been divided. For reasons of clarity, only one light-injecting element 100 carries a reference sign.

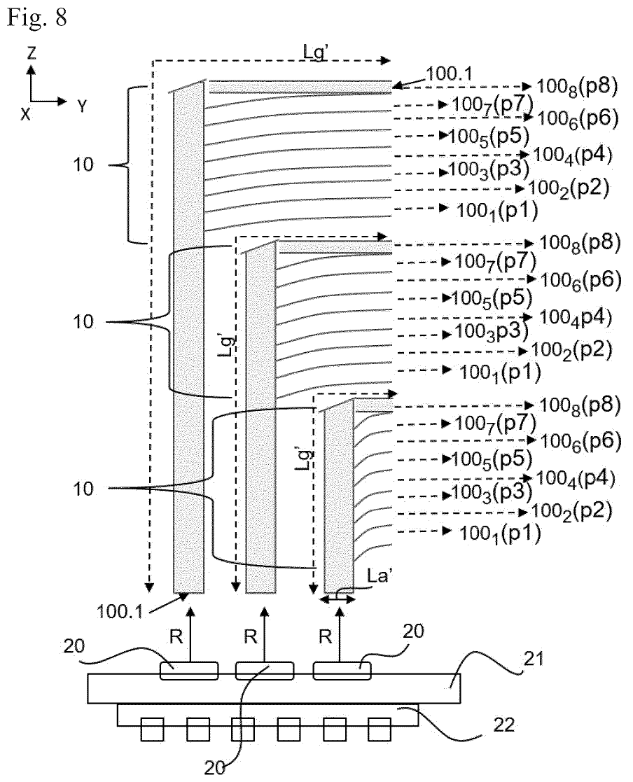

Each group 10 is coupled to at least one light source 20. Said at least one light source 20 is configured to emit light rays R (shown in FIGS. 6 and 8), which will be propagated by total reflection in the light-injecting elements 100 of the group 10, so as to transfer the light to the light guide sheet 11, which is adjacent to the light-injecting elements 100, and thus illuminate the regions 110 of the light guide sheet 11. In a non-limiting embodiment, each group 10 is coupled to a plurality of light sources 20. In another non-limiting embodiment, each group 10 is coupled to a single light source 20. The latter non-limiting embodiment is taken as a non-limiting example in the description which follows and in the non-limiting examples of FIGS. 2, 3 and 4.

As shown in FIG. 6, a light-injecting element 100 (also called a coupling bar 100 or light bar 100 or simply a bar 100) is configured to receive the light rays R emitted by the light source 20, which propagate and are totally reflected in said light-injecting element 100. The light-injecting element 100 has a rectangular or square cross section. The light-injecting element 100 comprises a length Lg′, a width La′ (both shown in FIG. 8), and a thickness e (shown in FIG. 6). Its thickness e is the same as the thickness e of the light guide 1. The light-injecting element 100 comprises two extremities 100.1, one of which is directly adjacent to and attached to the light guide sheet 11, and the other is configured to face said light source 20. The light rays R emitted by the light source 20 enter via an extremity 100.1 and are transmitted to the other extremity 100.1, then towards the light guide sheet 11. For reasons of clarity, only the extremities 100.1 of the light-injecting element 1008 of one group 10 carry a reference sign.

FIG. 8 illustrates three groups 10 of eight light-injecting elements designated 1001 to 1008. As illustrated in FIG. 8, a light-injecting element 100 of a group 10 is adjacent to at least one other light-injecting element 100 of said group 10. The light-injecting elements 100 at the extremities of the group 10 (namely 1001 and 1008) are adjacent to a single light-injecting element 100 of said group 10, while the so-called intermediate light-injecting elements 100, which are not arranged at the extremities of said group 10 (namely 1002 to 1007), are adjacent to two other light-injecting elements 100 of said group 10.

As illustrated in FIG. 7, the light-injecting elements 100 of a same group 10 extend along the axis y when unfolded and have different positions pj, with j=1 to N, N being an integer, in the direction +z. The further away a light-injecting element 100 is from the light sources 20, the higher its position pj. Thus, as shown in the non-limiting example of FIG. 8, the light-injecting element 1008 has position p8, while the light-injecting element 1001 has position pl.

When the light guide 1 is arranged on the front face of the automotive vehicle 3 for example, the surface of the light-injecting elements 100 is perpendicular to the axis x. It is noted that the axis x corresponds to the vehicle axis Ox.

As illustrated in FIG. 5, the light-injecting elements 100 are composed of:
a main part 100.2 which extends along the axis y, namely in the first direction of the light guide sheet 11 described below, and
an end part 100.3 which extends along the axis z, namely in the second direction of the light guide sheet 11 described below. The end part 100.3 is connected to the light guide sheet 11. The two parts 100.2 and 100.3 are separated by a fold 100.4. The end part 100.3 extends after the fold 100.4. In a non-limiting embodiment, the fold 100.4 is a right-angled fold. The length Lg′ of a light-injecting element 100 is the sum of the dimension of the main part 100.2 and the end part 100.3.

FIG. 5 illustrates the end parts 100.3, the main parts 100.2 of light-injecting elements 100 of a group 10, and the fold 100.4 separating them. FIG. 5 illustrates the end parts 100.3 of ten light-injecting elements 100 of a group 10, and a light source 20 coupled to said group 10.

The light-injecting elements 100 of a same group 10 have different lengths Lg′. For reasons of clarity, only the length Lg′ of the light-injecting elements 1008 carries a reference sign in FIG. 8. Also, a light-injecting element 100 of a group 10 has a different length Lg′ from the other light-injecting elements 100 of the same group 10. This allows them to be folded such that their end parts 100.3 form a stack 103 with a flat inlet surface 103.1, as shown in FIG. 6. The end part 100.3 of a light-injecting element 100 extends after the fold 100.4. In a non-limiting embodiment, the fold 100.4 is a right-angled fold.

Each light-injecting element 100 thus comprises a fold 100.4. The inlet surface 103.1 of the stack 103 is formed by one of the extremities 100.1 of each of the light-injecting elements 100 of the group 10, which are the extremities of their end parts 100.3.

As illustrated in FIG. 6, in each group 10, the light-injecting elements 100 are folded such that their end parts 100.3 form the stack 103 with a thickness E adapted to an emission surface of the light source 20. The thickness E is the sum of the thicknesses e of each light-injecting element 100, the end parts 100.3 of which form the stack 103. The stack 103 has an inlet surface 103.1, which is formed by the extremities of the end parts 100.3 of each of the light-injecting elements 100 of the group 10 and is configured to receive the light emitted by the light source 20.

As shown in FIGS. 6 and 8, in a non-limiting embodiment, the light source 20 coupled to the group 10 is arranged facing the inlet surface 103.1 of the stack 103. The light rays R of the light source 20 enter via this inlet surface 103.1 and thus propagate in the light-injecting elements 100. The light rays R are totally reflected inside the light-injecting elements 100 and are redirected via the folds 100.4 towards the light guide sheet 11.

It is noted that the further away a group 10 is from the light source 20, the greater the length Lg′ of the light-injecting elements 100. Thus the light-injecting element 1008 which is furthest away has the greatest length Lg′, while the closest light-injecting element 1001 has the smallest length Lg′. In this way, a flat inlet surface 103.1 can be obtained for the stack 103.

The light-injecting elements 100 of a same group 10 have a same width La′.

When there are multiple groups 10, the light-injecting elements 100 are arranged in the same fashion for all groups 10, namely:
they are adjacent to one another and folded with a fold 100.4 so as to form the stack 103 with its flat inlet surface 103.1,
the further away a group 10 is from the light source 20, the greater the length Lg′ of the light-injecting elements 100. Thus the length Lg′ of the light-injecting elements 100 increases progressively in the direction away from the light source 20. Thus the light-injecting element 100 which is furthest away from the light source 20 has the greatest length Lg′, while the closest light-injecting element 100 has the smallest length Lg′. In this way, a flat inlet surface 103.1 can be obtained for the stack 103. Thus the light-injecting elements 100 of a same group 10 have different lengths Lg′.

The light-injecting elements 100 of a group 10 illuminating a region 110 have a length Lg′ which is different from that of the light-injecting elements 100 of the other groups 10 illuminating another region 110.

In particular, a light-injecting element 100 at a position pj in a group 10 illuminating a region 110 has a length Lg′ which is different from that of a light-injecting element 100 of another group illuminating another region 110, at the same respective position pj. This allows the light sources 20 coupled to each group 10 to be located away from the light guide 1, so that they can be brought to a single given location and so that they can be arranged on a single electronic support 21, as shown in FIG. 8. Because there is only a single electronic support 21, the number of connectors can be reduced, since a single connector is sufficient. By reducing the number of connectors, the number of associated electrical connection harnesses can be reduced to a single electrical connection harness. In a non-limiting embodiment, the electronic support 21 is a PCBA (printed circuit board assembly). In a non-limiting example, the light sources 20, which are thus located further away, are arranged between 10 and 50 centimeters from the light guide 10.

In the application of the automotive vehicle 3, this allows the light sources 20 with the electronic support 21 to be placed remotely in a location behind the front face where there is space, or behind the headlight or rear light where there is space. Thus light sources 20 of high luminous power can be used, which are adapted to the application of the automotive vehicle 3 and are consequently larger than those of the prior art. Thus a heat sink 22 may be used (shown in FIG. 8) which is suitable for dissipating the heat emitted by the high-powered light sources 20, without being restricted in space. In a non-limiting embodiment, the light sources 20 have a luminous flux of 400 lumens per light source 20. In a non-limiting embodiment, in addition to the heat sink 22, a fan (not shown) may also be used for cooling the light sources 20.

It is noted that, because higher-powered light sources 20 may be used, it is possible to have a large surface area of the light guide sheet 11 (described below) with a plurality of regions 110, and thus be able to illuminate the different regions 110 effectively. Thus the light guide 1 may be used for example for the front face, the headlight or the rear light of the automotive vehicle 3, which extend over a large area.

It is noted that because the light-injecting elements 100 of a group 10 illuminating a region 110 have a length Lg′ different from that of the light-injecting elements 100 of the other groups 10 illuminating other regions 110, when the light-injecting elements 100 are folded, at their respective end part 100.3, it is possible for them to have different positions along the axis y (if they are projected onto the axis y) from those of the other groups 10, in contrast to the prior art in which they have the same position along the axis y (if they are projected onto the axis y) for all the groups. In the prior art, the inlet surfaces of the stacks are aligned along the axis z but situated at different levels on the axis z, whereas in the case of the light guide 1 described, the inlet surfaces 103.1 of the stacks 103 are aligned along the axis y and situated at different positions on the axis y. In other words, the inlet surfaces 103.1 of the light guide described are laterally offset relative to one another.

In the non-limiting example of FIG. 2 in which the light guide 1 comprises three groups 10, in a non-limiting embodiment, the group 10 which is furthest away from the light sources 20 (otherwise called the third group 10), and which illuminates a region 110, comprises light-injecting elements 100 of different length Lg′ from that of the light-injecting elements 100 respectively at the same position pj of the group 10 closest to the light sources 20 (otherwise called the first group 10), which illuminates another region 110. Described in other terms, the set of light sources may here be considered as a reference point situated towards the bottom of the figure, and in general situated on the side to which the light-injecting elements are directed when folded in the folding direction. The group furthest away from the reference point illuminates the region situated furthest away from the reference point. Here, the light-injecting elements of the group furthest away each have a length which is greater than that of the light-injecting elements 100 respectively at the same position pj of the group 10 situated closer to the reference point.

In particular, as shown in FIG. 8, the bar 1001 of the third group 10, which is at position p1, comprises a greater length Lg′ than the bar 1001 of the first group 10, which is at the same position p1, and the bar 1008 of the third group 10, which is at position p8, comprises a greater length Lg′ than the bar 1008 of the first group 10, which is at the same position p8. The same applies to the intermediate bars 1002 to 1007 respectively, at the respective positions p2 to p7. One can therefore be certain that the inlet surfaces 103.1 of the stacks 103 of the two groups 10 lie at different locations along the axis y.

The intermediate group 10 (otherwise called the second group 10), which is situated between the two other groups 10 and which illuminates a different region 110 from the other two groups 10, comprises light-injecting elements 100 of length Lg′ which is different from that of the light-injecting elements 100 respectively at the same position pj of the closest group 10. In particular, the bar 1001 of the second group 10, which is at position p1, comprises a greater length than the bar 1001 of the first group 10, which is at the same position pl, and the bar 1008 of the second group 10, which is at position p8, comprises a greater length Lg′ than the bar 1008 of the first group 10, which is at the same position p8. The same applies to the intermediate bars 1002 to 1007 respectively, at the respective positions p2 to p7. One can therefore be certain that the inlet surfaces 103.1 of the stacks 103 lie at different locations of the two groups 10 along the axis y.

In a non-limiting embodiment, the light-injecting elements 100 have a thickness e of around 50 μm (microns). In a non-limiting embodiment, the light-injecting elements 100 have a width La′ of between 1 and 20 millimeters. In a non-limiting embodiment, the light-injecting elements 100 have a length Lg′ of between 100 and 500 millimeters.

In a non-limiting embodiment, the light-injecting elements 100 of a group 10 have a different width La′ from the light-injecting elements 100 of the other groups 10. This allows illumination of different areas of regions 110 per group 10, and hence the use of a different number and/or different sizes of light sources 20.

The light guide sheet 11 is now described below.

As illustrated in FIGS. 2, 3 and 4, the light guide sheet 11 comprises:
a plurality of regions 110,
at least one light-emitting zone 111 incorporated in at least one region 110.

As the light guide 1 is sheet-like, flexible and transparent, the guide sheet 11 is consequently sheet-like, flexible and transparent. As the guide sheet 11 is flexible, it may be flat or curved, depending on the position in which it is placed and the mechanical stresses applied thereto. In particular, it is adapted to the front face or the headlight or the rear light of the automotive vehicle 3.

The light guide sheet 11 is adjacent to and attached to the light-injecting elements 100. Each region 110 is configured to be illuminated by a different group 10 of light-injecting elements 100. The different regions 110 are illuminated by groups 10 of light-injecting elements 100 of different sizes because of their different lengths Lg′.

The light guide sheet 11 also comprises at least one light-mixing region 112. The light which leaves a same group 10 of light-injecting elements 100 will be mixed in the light-mixing region 112, which allows a homogeneous illumination of the light-emitting zone 111 of the corresponding region 110.

A region 110 comprises said at least one light-emitting zone 111.

A light-emitting zone 111 is a zone through which the light generated by the light rays R of the light source 20 of the group 10 leaves the light guide sheet 11. In particular, it leaves in the direction +x, namely substantially parallel to the vehicle axis Ox, towards the outside of the front face of the automotive vehicle 3, in a non-limiting example considered.

According to a non-limiting embodiment, said at least one light-emitting zone 111 forms at least one pattern, otherwise called a pattern 111. In a non-limiting example, the pattern 111 has a size of 30×30 centimeters. In a non-limiting example, the pattern 111 is a logo or part of a logo. So in this case, an illuminated logo is obtained. In a non-limiting embodiment, the pattern is formed by microstructures. Such microstructures may generally, in non-limiting examples, have an embossed or relief form at which the light rays R are reflected. The microstructures are nanometric structures. In a non-limiting embodiment, the pattern 111 is identical to the manufacturer's pattern mentioned above. In this case, the pattern 111 covers the manufacturer's pattern when the light guide 1 is placed on the front face. Thus the manufacturer's pattern appears when the light source or sources 20 are activated.

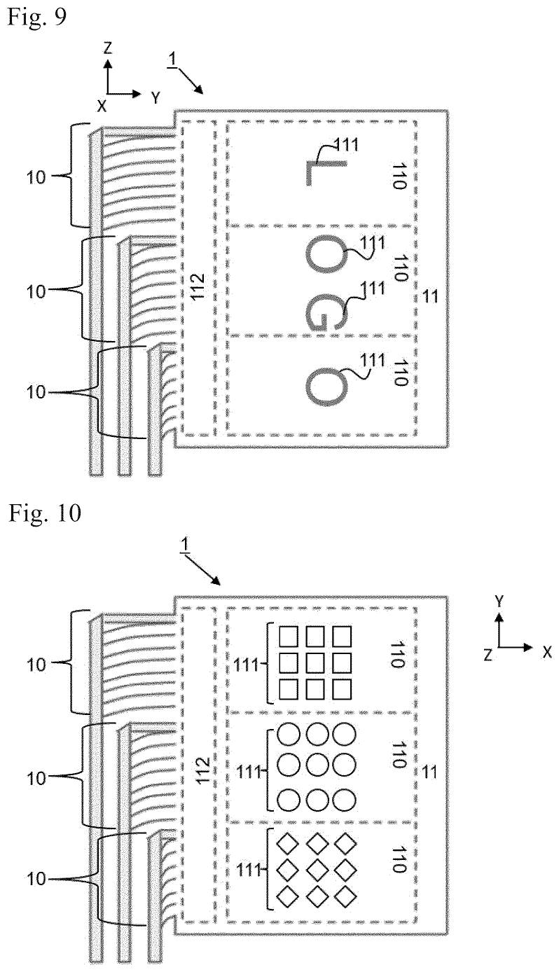

In the non-limiting examples of FIGS. 9 and 10, the light guide sheet 11 comprises three regions 110 and light-emitting zones 111 respectively incorporated in the three regions 110.

FIG. 9 illustrates a first non-limiting example of an illuminated pattern which is a logo. A first light-emitting zone 111 here forms an L of the logo, a second light-emitting zone 111 forms an O and a G of the logo, and a third light-emitting zone 111 here forms an O of the logo.

FIG. 10 illustrates a second non-limiting example of an illuminated pattern which comprises diamonds, circles and squares. A first light-emitting zone 111 forms the diamonds, a second light-emitting zone 111 forms the circles, and a third light-emitting zone 111 forms the squares.

The assembly of light guide 1, light sources 20, electronic support 21 and heat sink 22 forms a luminous device 2 shown in FIGS. 11 to 15.

The luminous device 2 thus comprises:
at least one above-described light guide 1,
a plurality of light sources 20 arranged on at least one same electronic support 21, and
at least one heat sink 22.

A group 10 of said light guide 1 is coupled to one or more light sources 20. The assembly of a group 10 of injecting elements 100 and one or more associated light sources 20 is otherwise known as an inlet coupler 13. Thus an inlet coupler 13 is associated with each region 110 of the light guide sheet 11. For reasons of clarity, only one inlet coupler 13 carries a reference sign in FIGS. 11 to 13.

In a non-limiting embodiment, the light sources 20 are semiconductor light sources. In a non-limiting embodiment, the semiconductor light sources form part of a light-emitting diode or a laser diode. “Light-emitting diode” means any type of light-emitting diode, including, by way of non-limiting example, LEDs (light-emitting diodes), OLEDs (organic LEDs), AMOLEDs (active-matrix organic LEDs), or FOLEDs (flexible OLEDs).

In a non-limiting embodiment, the light sources 20 are activatable independently of one another. This allows each region 110 of the light guide sheet 11 to be illuminated independently of each other, and hence the creation of animations. So, in the example of FIG. 9, an animated illuminated logo may be created. So, in the example of FIG. 10, the diamonds, the circles and squares may be illuminated alternately to create an animation.

According to an exemplary embodiment, the number of light sources 20 is adapted to the size (length Lg′, width La′, thickness e) of the light-injecting elements 100 of a group 10. Thus it is possible to have a same number of light sources 20 per group 10, or different numbers of light sources 20 per group 10. Similarly, it is possible to have different sizes of light sources 20 per group 10, or light sources 20 of the same size for all groups 10. In non-limiting examples of the drawings, the same number of light sources 20 is present per group 10, namely here a single one, and the light sources 20 are of the same size. In a non-limiting example, the emission surface area of a light source 20 is 1 mm². According to another exemplary embodiment, the number of light-injecting elements 100 is adapted to the number of light sources 20 used to meet the need for the desired luminance.

FIGS. 11, 12 and 13 illustrate a first embodiment of the luminous device 1, in which:
said luminous device 1 comprises a single light guide 1,
the groups 10 of light-injecting elements 100 of this light guide 1 are arranged on a same side of the light guide sheet 11 and thus form a first set of light-injecting elements 100,
the light sources 20 of all groups 10 are arranged on a same electronic support 21.

Because the groups 10 of light-injecting elements 100 are all arranged on a same side of the light guide sheet 11, the corresponding light sources 20 are all arranged on a same side and may therefore be placed on a same electronic support 21. A single electronic support 21 is therefore necessary. Consequently, a single heat sink 22 is used. Thus, in this first non-limiting embodiment, the luminous device 2 comprises a single heat sink 22. Naturally, it would also be possible to have a plurality of electronic supports.

In the non-limiting example illustrated in FIGS. 11 and 12, there are three groups 10 and three light sources 20 respectively coupled to the three groups 10, and the three groups 10 are arranged on a same side 11.1 of the light guide sheet 11. In the non-limiting example, the light guide sheet 11 comprises three regions 110. Each group 10 illuminates a different region 110.

In a first non-limiting variant embodiment of this first non-limiting embodiment shown in FIG. 11, the light sources 20 are arranged on a same plane of said same electronic support 21.

Thus, each light source 20 is situated at the same distance d from the three inlet surfaces 103.1 of the three stacks 103 formed by the light-injecting elements 100 of the respective three groups 10.

As there are groups 10 of light-injecting elements 100 with different lengths Lg′, there is a possible risk of non-homogeneity between the groups 10. In fact, the path taken by the light generated by the light rays R is shorter in the group 10 closest to the light sources 20 than for the other two groups 10 which are further away. For the group 10 which is furthest away, in which the light-injecting elements 100 are longest, there may therefore be a loss of efficiency in the light propagation. In order to maintain the efficiency of the light propagation, in a non-limiting embodiment of this first variant, a set of light sources 20 coupled to a group 10 is supplied by a different current from the other sets of light sources 20 coupled to the other groups 10. It is recalled that a set may comprise one or more light sources 20; in the present case, it comprises only a single light source 20. Thus, in the non-limiting example illustrated in FIG. 11, the light source 20 of a group 10 is supplied by a different current from the light source 20 of the other groups 10. This means having a specific current, here designated i, i′, i″, per region 110 of the light guide sheet. The further a group 10 is situated from the light sources 20, the stronger the associated current i must be in order to maintain the efficiency of the light propagation. The current i″ is thus the strongest, and the current i is the weakest. In a non-limiting example, the current i″ is 260 mA for the group 10 which is furthest away, the current i′ is 255 mA for the intermediate group, and the current i is 250 mA for the closest group 10. Thus the uniformity of global illumination over all regions 110 of the light guide sheet 11 is guaranteed.

In a non-limiting embodiment of the first non-limiting embodiment variant illustrated in FIG. 12, the luminous device 2 also comprises at least one light collimator 23 coupled to the light sources 20. Said at least one light collimator 23 is arranged between the light sources 20 and the stacks 103 described above. In particular, it is arranged facing the inlet surface 103.1 of a stack 103. In a non-limiting embodiment, the light collimator 23 is an optical lens. As illustrated in FIG. 12, the luminous device 2 comprises three light collimators 23 coupled respectively to the light sources 20 of the three groups 10 of light-injecting elements 100. Each light collimator 23 is arranged facing a stack 103, in particular its inlet surface 103.1. The light collimators 23 allow reduction in the light losses of the light sources 20 and hence an increase in the efficiency of the light propagation when the light-injecting elements 100 have a low thickness e (between 1 and 5 mm). Also, the light collimators 23 serve as intermediate pieces between the light sources 20 and the inlet surfaces 103.1 of the stacks 103. This makes it possible to avoid the light sources 20 being too close to the inlet surfaces 103.1, which could burn them. Because the light sources 20 are remote from the light guide sheet 11, there is room to add such light collimators 23.

In a second non-limiting variant embodiment of this first non-limiting embodiment shown in FIG. 13, each light source 20 is arranged on a different plane of said same electronic support 21 from the other light sources 20, and is supplied by a same current i. The electronic support 21 thus comprises steps, and each light source 20 is situated on a different step. Thus each light source 20 is situated at a different distance, here d, d′, d″, from the three inlet surfaces 103.1 of the three stacks 103 described above. This allows the efficiency of the light propagation to be maintained. The light source 20 coupled to the group 10 which is furthest away from the light sources 20 is that which is arranged at the smallest distance d″. The light source 20 coupled to the group 10 which is closest to the light sources 20 is that which is arranged at the greatest distance d. In the non-limiting case of the three light sources 20, in a non-limiting example, the light source 20 of the group 10 which is furthest away is arranged at a distance d″ of 0.4 mm (millimeters) from the inlet surface 103.1 of its corresponding stack 103. The light source 20 of the nearest group 10 is arranged at a distance d of 0.5 mm from the inlet surface 103.1 of its corresponding stack 103. Finally, the light source 20 of the intermediate group 10 is arranged at a distance d′ of 0.45 mm from the inlet surface 103.1 of its corresponding stack 103. The distance d, d′, d″ of the light sources relative to the inlet surface 103.1 of the corresponding stack 103 is thus adjusted as a function of the length Lg′ of the light-injecting elements 100, so as to supply the light sources 20 with a same current i.

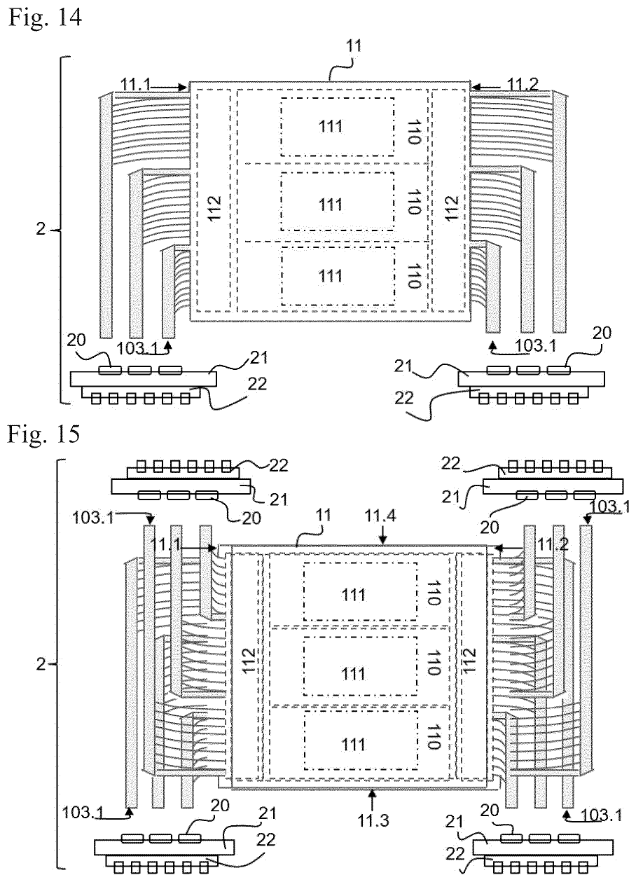

FIG. 14 illustrates a second embodiment of the luminous device 1, in which:
said light device 1 comprises a single light guide 1,
the plurality of groups 10 of light-injecting elements 100 is arranged on a first side 11.1 of said light guide 1 and thus forms a first set of light-injecting elements 100, and a second set, identical to the first set, is arranged on a second side 11.2 of said light guide sheet 11, opposite the first side 11.1, so as to be symmetrical to the first set relative to the light guide sheet 11,
the light sources 20 coupled to the first set are arranged on a first same electronic support 21, and the light sources 20 coupled to the second set are arranged on a second same electronic support 21, different from the first electronic support 21.

Thus, in the non-limiting example of FIG. 14, there are two sets of three groups 10: a first set of three groups 10 situated on a side 11.1 of the light guide sheet 11, and a second set of three other groups 10 situated on the other side 11.2 opposite the first side 11.1. The light guide sheet 11 comprises two light-mixing regions 112 opposite each of the two sets of three groups 10. In the non-limiting example, the light guide sheet 11 comprises three regions 110. Each group 10 of a set illuminates a different region 110 from another group 10 of the same set. A group 10 of the first set illuminates the same region as another group 10 of the second set.

This second non-limiting embodiment allows an increase in illumination of the regions 110, since there is illumination from both sides of the light guide sheet 11, instead of one side in the case of the first non-limiting embodiment. This also allows a reduction in the luminous power of the light sources 20, so as to have two smaller heat sinks 21 which are less bulky than in the case of the first non-limiting embodiment, where only a single heat sink 21 is provided in a non-limiting embodiment. In the non-limiting example illustrated, there are twice as many light sources 20 as in the first non-limiting embodiment, since there are twice as many groups 10. The first non-limiting embodiment variant (light sources 20 on a same plane) of the first non-limiting embodiment, and the second non-limiting embodiment variant (light sources 20 on different planes) of the first non-limiting embodiment, can be applied to the second non-limiting embodiment, either in isolation or in combination.

FIG. 15 illustrates a third embodiment of the luminous device 1, in which said luminous device 1 comprises at least two superposed light guides 1 which are oriented opposite to one another. In the non-limiting example of FIG. 15, the luminous device 1 comprises two light guides 1 as described in the second embodiment of FIG. 14, namely which each comprise two sets of groups 10 of light-injecting elements 100, each set being arranged on one side 11.1 and on the other opposite side 11.2 of the light guide sheet 11. The two light guides 1 are oriented opposite to one another in that the inlet surfaces 103.1 of their stacks 103 are respectively arranged along the two other opposite sides 11.3 and 11.4. Thus in FIG. 15, it is evident that the two inlet surfaces 103.1 of the two stacks 103 of the first light guide 1 are arranged along a third side 11.3 of the light guide sheet 11, and the two inlet surfaces 103.1 of the two stacks 103 of the second light guide 1 are arranged along a fourth side 11.4 of the light guide sheet 11, said fourth side 11.4 being opposite the third side 11.3. In the non-limiting example illustrated, there are twice as many light sources 20 as in the second non-limiting embodiment; thus there are four electronic supports 21 and four heat sinks 22. The light guide sheet 11 comprises four light-mixing regions 112 opposite each of the two sets of three groups 10 of each light guide 1. For reasons of clarity in the drawing, only a single light source 20 per electronic support 21 carries a reference sign, and only four inlet surfaces 103.1 carry a reference sign. In the non-limiting example, the light guide sheet 11 comprises three regions 110. Each region 110 is illuminated by four groups 10. In particular, each region 110 is illuminated by a group 10 of a first set and by a group 10 of a second set of each light guide 1.

This third non-limiting embodiment allows creation of an animation with two superposed patterns, for example. Thus in a non-limiting example, the two light guides 1 are arranged on a rear light of the automotive vehicle 3, such as a rear position light. In this case, the first light guide 1 may comprise a first light-emitting zone 111 forming a first pattern, and the second light guide 1 may comprise a second light-emitting zone 111 forming a second pattern, superposed on the first pattern. When the position light is lit, the light sources 20 associated with the first light guide 1 are activated and the first pattern is thus illuminated, while the light sources 20 associated with the second light guide 1 are deactivated; the second pattern is thus not illuminated. When the driver brakes, the light sources 20 associated with the second light guide 1 are activated and the second pattern may thus also be illuminated, and hence illuminated superposed over the first pattern if the two patterns are identical. When the driver brakes, the light sources 20 associated with the second light guide 1 are activated and the second pattern may thus also be illuminated, and serve as an additional complement to the first pattern.

Of course, the description of the invention is not limited to the embodiments described above and to the field described above. Thus the invention may be applied to any application, other than the vehicle application, requiring a large light-emitting surface. Thus, in a third embodiment variant of the first non-limiting embodiment, instead of having light sources on different planes with steps on the electronic support 21, or different currents to supply the light sources 20 situated on a same plane, light sources 20 may be arranged on a same plane of the electronic support 21 and the inlet surfaces 103.1 offset relative to one another with respect to the axis x. They would no longer be aligned along the axis x. Thus the inlet surface 103.1 of the stack 103 of the group 10 which is furthest away from the light sources 20 would be nearer than the other two, and the inlet surface 103.1 of the stack 103 of the group 10 which is closest to the light sources 20 would be the furthest away of the other two along the axis x.

The invention described thus in particular has the following advantages:
it allows use of a flexible surface light guide 1 adapted for vehicle applications with large surface areas to be illuminated, —it allows use of a luminous device 2 with light sources 20 which have sufficient luminous power to illuminate the light guide sheet 11 of a light guide 1, —it allows a reduction in the number of electronic supports compared with the prior art, so as to have only a single electronic support 21 when all light sources 20 are situated on a same side of the light guide sheet 11, which allows a reduction in the size, weight and cost of the luminous device 2, —by reducing the number of electronic supports, it allows a reduction in the number of associated connectors and the number of associated electrical connection harnesses, which allows a reduction in the size, weight and cost of the luminous device 2, —by moving the light sources 20 away from the light guide sheet 11, it allows the light sources 20 to be located in an unconfined space where there is room, and thus allows use of light sources 20 of higher luminous power than those of the prior art if so desired; it also allows the possibility of placing one or more heat sinks 21, adapted to the size and luminous power of the light sources 20, in an unconfined space; thus the size of the heat sink(s) may be increased relative to the prior art; —it makes it possible to obtain a more efficient and greater illumination for the light guide sheet 11 and its regions 110, —it allows an increase in the light-emitting surface area, namely the total surface area of the regions 110 of the light guide sheet 11 which are illuminated, without reducing the efficiency of the illumination, —it allows the use of an illuminated logo, which can be animated if required.

1. A flexible surface light guide for vehicle (3), the light guide comprising:
a plurality of groups of light-injecting elements and a light guide sheet, each group being coupled to at least one light source,
the light guide sheet includes a plurality of regions, at least one light-emitting zone being incorporated into at least one region, the light guide sheet being adjacent to the light-injecting elements each group being configured to illuminate a region in the light guide sheet,
and in that the light-injecting elements of a group illuminating a region have a length which is different from that of the light-injecting elements of the other groups illuminating another region.

2. The light guide as claimed in claim 1, wherein in each group of light-injecting elements, the light-injecting elements are folded so as to form a stack with a thickness adapted to an emission surface of a light source, the stack having an inlet surface configured to receive the light emitted by the light source.

3. The light guide as claimed in claim 2, wherein the light-injecting elements are dimensioned in such a way that the inlet surfaces of the groups of light-injecting elements are at the same level when the light-injecting elements of each of the groups are folded.

4. The light guide as claimed in claim 1, wherein the at least one light-emitting zone forms at least one pattern.

5. The light guide as claimed in claim 1, wherein the plurality of groups of light-injecting elements is arranged on a same side of the light guide sheet and thus forms a first set of light-injecting elements.

6. The light guide as claimed in claim 1, wherein the plurality of groups of light-injecting elements is arranged on a first side of the light guide sheet and thus forms a first set of light-injecting elements, and wherein the light guide includes a second set identical to the first set, the second set being arranged on a second side of the light guide sheet opposite the first side, so as to be symmetrical to the first set relative to the light guide sheet.

7. A luminous device for a vehicle, comprising at least one light guide, a plurality of light sources and at least one heat sink, wherein the at least one light guide includes a plurality of groups of light-injecting elements and a light guide sheet, each group being coupled to some of the plurality of light source, the light guide sheet includes a plurality of regions, at least one light-emitting zone being incorporated into at least one region, the light guide sheet being adjacent to the light-injecting elements, each group being configured to illuminate a region in the light guide sheet, and in that the light-injecting elements of a group illuminating a region have a length which is different from that of the light-injecting elements of the other groups illuminating another region.

8. The luminous device as claimed in claim 7, wherein the light sources are arranged on a same electronic support.

9. The luminous device as claimed in claim 8, wherein the light sources are arranged on a same plane of the same electronic support.

10. The luminous device as claimed in claim 8, wherein each light source is arranged on a different plane of the same electronic support from the other light sources.

11. The luminous device as claimed in claim 7, wherein the luminous device includes at least two superposed light )guides which are oriented opposite to one another.
